(19) United States
(12) Patent Application Publication
(10) Pub. No.: US 2024/0076804 A1
(43) Pub. Date: Mar. 7, 2024

(54) NOZZLE BLOCK HAVING CLEANING MEANS, AND ELECTROSPINNING DEVICE HAVING SAME

(71) Applicant: Jong-Su PARK, Seoul (KR)

(72) Inventors: Jong-Su PARK, Seoul (KR); Chae-keun LIM, Seoul (KR); Woong HUH, Incheon (KR); Woong-jun HWANG, Bucheon-si, Gyeonggi-do (KR); Chun-su LEE, Siheung-si, Gyeonggi-do (KR); Youn-chang LEE, Siheung-si, Gyeonggi-do (KR); Yong-rae ROH, Goyang-si, Gyeonggi-do (KR)

(21) Appl. No.: 18/272,339

(22) PCT Filed: Dec. 16, 2021
(86) PCT No.: PCT/KR2021/019235

§ 371 Date: Jul. 13, 2023

(30) Foreign Application Priority Data
Dec. 14, 2021 (KR) 10-2021-0179169

(51) Int. Cl. D01D 4/04; D01D 4/02; D01D 5/00

(52) U.S. Cl. CPC D01D 4/04; D01D 4/02; D01D 5/0069

(57) ABSTRACT

Disclosed is a nozzle block applied to an electrospinning device. At least one piercing unit (means of piercing) having a diameter smaller than the inner diameter of a spinning nozzle is coaxially disposed inside the spinning nozzle in order to prevent solidification of a solution at a tip of the spinning nozzle. The present disclosure includes a first cleaning mechanism for cleaning the spinning nozzle by reciprocating the piercing unit and the spinning nozzle relative to each other so that the tip of the spinning nozzle is unclogged, and a second cleaning mechanism for cleaning aggregates deposited around and outside the tip of the spinning nozzle through chemical cleaning and/or physical cleaning when the electrospinning process is temporarily stopped or after the electrospinning process is completed.

### TECHNICAL FIELD

The present application claims priority to Korean Patent Application No. 10-2021-0179169 filed on Dec. 14, 2021 in the Republic of Korea, the disclosures of which are incorporated herein by reference.

The present disclosure relates to an electrospinning device, and more specifically, to a nozzle block having various cleaning units for cleaning a spinning nozzle of an electrospinning device when the spinning nozzle is clogged or contaminated by solidification of a polymer material, and an electrospinning device including the nozzle block.

### BACKGROUND ART

The electrospinning process is a process of manufacturing nanofibers in an environment where an electric field is formed by applying direct current of high voltage of thousands to tens of thousands of volts to a solution and connecting a ground or (−) voltage to a collector.

Such an electrospinning process is usually implemented by an electrospinning device. The electrospinning device is classified into a top-down electrospinning device in which the collector is located below the injection nozzle and a bottom-up electrospinning device in which the collector is located above the injection nozzle. However, according to the top-down electrospinning device, cohesive residues generated by solidification at the front end of the spinning nozzle during the spinning process fall to the lower integration portion where the nanofibers are stacked, and thus there is a limitation in manufacturing a high-quality nanofiber web. Therefore, because of the above problem, the electrospinning process for mass production of nanofibers mainly adopts the bottom-up electrospinning device.

The spinning nozzle for producing nanofibers uses a nozzle composed of capillary needles. The nozzle is not clogged when the solution is continuously discharged during the electrospinning process. However, if the process is temporarily stopped, there is a problem in that the nozzle is clogged due to solution solidification caused by solvent volatilization at the tip of the nozzle, which makes it difficult to proceed with the subsequent process. This phenomenon often occurs in the process of manufacturing nanofibers from a solution prepared using a highly volatile solvent.

For example, when manufacturing polyvinylidene fluoride (PVDF) nanofibers by electrospinning, the PVDF solution a mixed solution of dimethylacetamide (DMAc) and acetone with an increased proportion of acetone as a solvent in order to increase the solvent volatilization rate. At this time, the proportion of acetone is in the range of 50% to 90% to prepare nanofibers.

However, as the proportion of acetone increases, the solvent volatilization increases and aggregates are formed more frequently at the nozzle tip. In particular, since polymers for bio use a highly volatile solvent, there is a problem in that the nozzle is easily clogged when the process is stopped for a while.

Meanwhile, poly(caprolactone) (PCL)/acetic acid solution, poly(lactic acid) (PLA)/dichloromethane solution, silk/formic acid solution, and nylon/formic acid solution have a problem that the nozzle tip is often clogged due to the rapid volatilization of the solvent.

Various researches and developments have been made to solve the problem that the nozzle for discharging the spinning solution is clogged due to solidification of a polymer material when the nanofiber manufacturing process by the electrospinning method is temporarily stopped.

Patent Literature 1 (Korean Patent Registration No. 10-1178171) relates to a nozzle block for preventing clogging and contamination of a nozzle and a bottom-up electrospinning device including the same. Here, in case the injection work from the injection nozzle is stopped during the electrospinning process, in order to prevent the solvent contained in the spinning solution from evaporating through the end of the injection nozzle, the injection nozzle is completely submerged in the anti-solidification solution, and when the work of spraying the spinning solution from the injection nozzle is resumed, the anti-solidification solution is recovered by an anti-solidification solution receiving portion for recovering the anti-solidification solution. Due to this, even if the nanofiber manufacturing process is temporarily stopped, it is possible to prevent the nozzle from being clogged or contaminated.

Meanwhile, Patent Literature 2 (Korean Patent Registration No. 10-2025159) discloses a nozzle device for electrospinning, which includes a needle wire stopper for needle insertion installed to be insertable into the capillary needle of the spinning nozzle to prevent the solution from solidifying at the tip of the spinning nozzle, and a cleaning injection nozzle for removing deposits by injecting a solvent to the tip of the spinning nozzle. In Patent Literature 2, when the electrospinning process is stopped, the needle wire stopper for needle insertion is moved to the front of the capillary needle of the spinning nozzle, so that the needle wire stopper for needle insertion is inserted into the capillary needle to prevent clogging of the nozzle tip. In addition, the cleaning injection nozzle performs a cleaning process of removing deposits by injecting a solvent to the tip of the capillary needle after the needle wire stopper for needle insertion is separated from the capillary needle of the spinning nozzle.

Through this, in Patent Literature 2, the solution is prevented from solidifying at the tip of the spinning nozzle when the electrospinning process is stopped, so that the electrospinning process may be stably performed without clogging the nozzle in the next process.

In addition, Patent Literature 3 (Korean Patent Registration No. 10-2176015) invented by the inventors of this application discloses a nozzle block, which includes at least one piercing unit having a smaller diameter than the spinning needle and disposed coaxially inside the spinning needle, and a nozzle clogging preventing unit having a reciprocating mechanism for reciprocating the piercing unit and the spinning needle relative to each other. In Patent Literature 3, even if the electrospinning process is temporarily stopped, it is possible to prevent the solution from solidifying at the tip of the spinning nozzle or the spinning nozzle from being clogged by external contaminants.

### DISCLOSURE

### Technical Problem

The present disclosure is directed to providing a

The first technical object of the present disclosure is to prevent a solution from solidifying at a tip of a spinning nozzle or the spinning nozzle from being clogged by external contaminants even if an electrospinning process is temporarily stopped.

In addition, the second technical object of the present disclosure is to clean the spinning nozzle by completely cleaning and removing spinning aggregates deposited around and outside the tip of the spinning nozzle.

### Technical Solution

According to the first aspect of the present disclosure, there is provided a nozzle block applied to electrospinning, comprising: a spinning nozzle having a plurality of hollow spinning needles for discharging a spinning solution to the outside; a piercing unit having a smaller diameter than the spinning needle and disposed coaxially with the spinning needle; at least one rotating brush disposed on the left and/or right side of each spinning needle to clean the outside of the spinning needle by rotation; and a reciprocating unit configured to reciprocate the piercing unit and the spinning needle relative to each other, wherein clogging of a tip of the spinning needle is pierced by reciprocating the piercing unit and the spinning needle relative to each other, and aggregates deposited on the outside of the tip of the spinning needle are cleaned by using the at least one rotating brush.

In another embodiment, the nozzle block according to the first aspect of the present disclosure may further comprise a cleaning nozzle including a cleaning needle having an inner diameter greater than the outer diameter of the spinning needle and disposed to coaxially surround the spinning needle to clean the tip of the spinning needle by discharging a cleaning solvent.

In another embodiment, the nozzle block according to the first aspect of the present disclosure may further comprise a rotating unit configured to linearly reciprocate the rotating brush with respect to the spinning needle and rotate the rotating brush around a central axis.

In another embodiment of the nozzle block according to the first aspect of the present disclosure, the rotating brush may be a brush having a roll comb disposed on a round bar or a brush having a tail comb disposed on a round bar.

In another embodiment, the nozzle block according to the first aspect of the present disclosure may further comprise a hollow guide needle disposed below the spinning needle to be spaced apart by a predetermined distance in a coaxial direction and having an inner diameter and outer diameter equal to or greater than that of the spinning needle to guide the piercing unit to accurately enter the inside of the spinning needle without error.

In another embodiment of the nozzle block according to the first aspect of the present disclosure, a separation distance between the spinning needle and the guide needle may be 1 mm to 10 mm.

In another embodiment of the nozzle block according to the first aspect of the present disclosure, the piercing unit may be coaxially disposed inside the guide needle, and a front end of the piercing unit may be located at the same level as a front end of the guide needle or located therebelow within 5 mm.

In another embodiment of the nozzle block according to the first aspect of the present disclosure, the diameter of the piercing unit may be smaller than the inner diameter of the spinning needle by 0.005 mm to 1 mm.

In another embodiment of the nozzle block according to the first aspect of the present disclosure, the piercing unit may be a wire having a diameter smaller than the inner diameter of the spinning needle or a hollow piercing needle having an outer diameter smaller than the inner diameter of the spinning needle.

In another embodiment of the nozzle block according to the first aspect of the present disclosure, the reciprocating unit may be a pneumatic driving mechanism for reciprocating the piercing needle up and down relative to the spinning needle.

In another embodiment of the nozzle block according to the first aspect of the present disclosure, the cleaning needle may have an inner diameter greater than the outer diameter of the spinning needle by 0.1 mm to 5 mm.

In another embodiment of the nozzle block according to the first aspect of the present disclosure, the cleaning needle may be disposed coaxially below a front end of the spinning needle by 0.1 mm to 5 mm.

In another embodiment of the nozzle block according to the first aspect of the present disclosure, the at least one rotating brush may be a pair of rotating brushes disposed on left and right sides of a front end of the spinning needle to be spaced apart from each other by a predetermined distance.

In another embodiment of the nozzle block according to the first aspect of the present disclosure, the piercing needle may be protruded so that the piercing needle has a protrusion length of 0.5 mm to 20 mm.

In another embodiment, the nozzle block according to the first aspect of the present disclosure may further comprise a first nozzle support configured to support and fix at least two spinning needles arranged in a row; a second nozzle support configured to support and fix at least two guide needles arranged in a row so as to correspond to the spinning needles fixed to the first nozzle support; and a third nozzle support configured to support and fix at least two piercing needles arranged in a row so as to be guided into the guide needles fixed to the second nozzle support.

In another embodiment, the nozzle block according to the first aspect of the present disclosure may further comprise a fourth nozzle support configured to support and fix at least two cleaning needles arranged in a row so as to coaxially surround at least a part of a front end of the spinning needle.

According to the second aspect of the present disclosure, there is provided an electrospinning device, comprising: an unwinding unit configured to unwind a substrate to be stacked with nanofibers by spinning a spinning solution; a winding unit configured to wind the substrate on which the nanofibers are stacked; a nozzle block according to any one of the said embodiments; a collector configured to transfer the substrate to stack the nanofibers emitted from the nozzle block; a solution reservoir configured to store the spinning solution; a solution transfer mechanism configured to transfer the solution of the solution reservoir to the nozzle block; and a high voltage power supply configured to apply a high voltage to the spinning solution discharged from the spinning needle of the nozzle block.

In another embodiment, the electrospinning device according to the second aspect of the present disclosure may further comprise a robot driving unit configured to reciprocate the nozzle block in a width direction of the substrate; and a spinning distance adjusting unit configured to adjust a distance between the collector and the tip of the spinning needle.

In another embodiment, the electrospinning device according to the second aspect of the present disclosure may further comprise a hot air generator configured to produce fine nanofibers by volatilizing a solvent from a large amount of spinning filaments discharged from the spinning needles of the nozzle block; a humidity controller configured to control a solvent volatilization rate by adjusting internal humidity; and a laminator configured to adjust a coupling state of the nanofibers formed on the substrate.

In another embodiment, the electrospinning device according to the second aspect of the present disclosure may further comprise a video camera configured to monitor a solidified state or clogged state of the spinning solution formed at a front end of the spinning needle or a droplet state of Taylor cone formed at the tip of the spinning needle in real time.

In another embodiment, the electrospinning device according to the second aspect of the present disclosure may further comprise a collection guide unit disposed on left and right sides of the nozzle block to stack the spun nanofibers in a limited area of the collector.

### Advantageous Effects

According to the present disclosure, since the spinning nozzle can be prevented from being clogged even if the nanofiber manufacturing process is temporarily stopped, first, the nanofiber manufacturing process can be continuously performed, and second, the labor and cost required for replacing the nozzle can be greatly reduced compared to the prior art.

In addition, it is possible to manufacture a high-quality nanofiber-stacked web or membrane by cleaning solids or contaminants that are aggregated on the outside of the tip of the injection nozzle using chemical and physical cleaning units, and nanofibers can be continuously mass-produced without stopping the process.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is an exploded perspective view showing a nozzle block according to a preferred embodiment of the present disclosure.

FIG. 2 is a combined perspective view showing the nozzle block according to a preferred embodiment of the present disclosure.

FIG. 3 is a needle arrangement diagram showing the mutual arrangement relationship between needles before piercing.

FIG. 4 is a needle arrangement diagram showing the mutual arrangement relationship between needles after piercing.

FIG. 5 is a needle arrangement diagram showing the mutual arrangement relationship between needles during solvent cleaning.

FIGS. 6(a), 6(b) and 6(c) are a side view, a front view and a perspective view showing a rotating brush according to the present disclosure, respectively.

FIG. 7 is a diagram showing a top-down roll-to-roll electrospinning device according to a preferred embodiment of the present disclosure.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

Hereinafter, preferred embodiments of the present disclosure will be described in detail with reference to the accompanying drawings. The accompanying drawings are not drawn to scale, and like reference numbers in each drawing indicate like elements.

In the present disclosure, at least one piercing unit (means of piercing) having a diameter smaller than the inner diameter of a spinning nozzle is coaxially disposed inside the spinning nozzle in order to prevent solidification of a solution at a tip of the spinning nozzle even if the electrospinning process is temporarily stopped, and the present disclosure includes a first cleaning mechanism for cleaning the spinning nozzle by reciprocating the piercing unit and the spinning nozzle relative to each other so that the tip of the spinning nozzle is unclogged, and a second cleaning mechanism for cleaning aggregates deposited around and outside the tip of the spinning nozzle through chemical cleaning and/or physical cleaning when the electrospinning process is temporarily stopped or after the electrospinning process is completed.

The first cleaning mechanism is achieved by coaxially disposing a piercing unit having a diameter smaller than the inner diameter of the spinning nozzle inside the spinning nozzle. In addition, the second cleaning mechanism includes a chemical washing mechanism characterized in that a cleaning solvent injection nozzle having an inner diameter greater than the outer diameter of the spinning nozzle is coaxially disposed outside the spinning nozzle and a physical washing mechanism characterized in that at least one rotating brush is disposed on a left and/or right side of the tip of the spinning nozzle.

The piercing unit may be configured using a nozzle of the same shape as the spinning nozzle or a wire or needle with a small diameter, and the cleaning solvent injection nozzle may be configured using a nozzle or needle of the same shape as the spinning nozzle.

In addition, the present disclosure includes a first driving unit (first means of driving) for relatively reciprocating the piercing unit with respect to the spinning nozzle and a second driving unit (second means of driving) for relatively reciprocating or rotating the brush with respect to the spinning nozzle.

The first driving unit or the second driving unit may be a manual driving mechanism such as a spring or a handle or an automatic driving mechanism using a motor or pneumatic pressure.

Hereinafter, a number of embodiments and modifications for concretely realizing the above technical solution principle of the present disclosure will be described in detail with reference to the drawings.

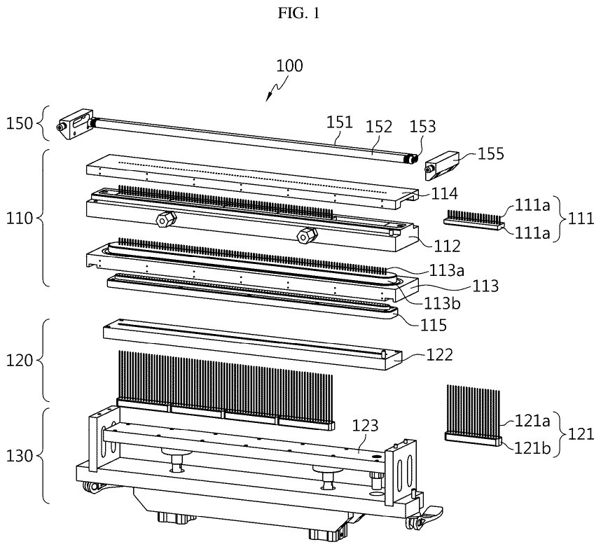

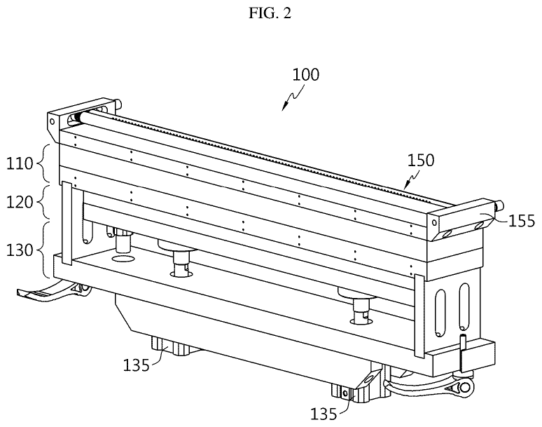

FIG. 1 is an exploded perspective view showing a nozzle block according to a preferred embodiment of the present disclosure, and FIG. 2 is a combined perspective view showing the nozzle block according to a preferred embodiment of the present disclosure.

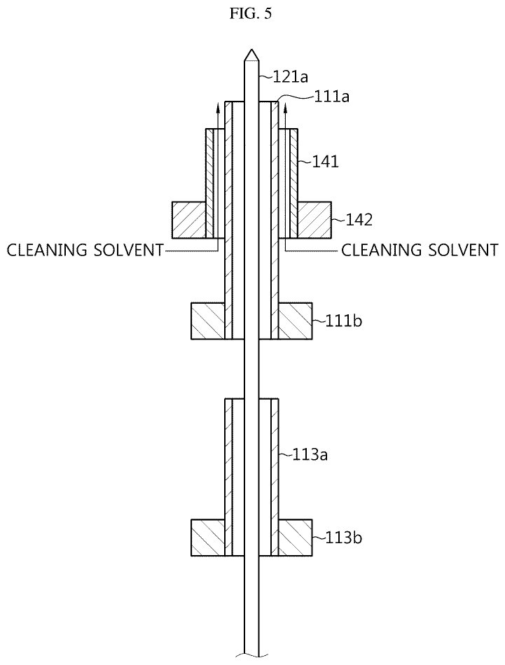

Referring to FIGS. 1 and 2, a nozzle block 100 for an electrospinning device according to a preferred embodiment of the present disclosure includes a spinning nozzle unit 110 having a plurality of spinning needles 111a for spinning a spinning solution introduced from a solution reservoir and stored therein to the outside, a piercing unit 120 having a plurality of piercing needles 121a coaxially disposed on the spinning needle 111a and having a diameter smaller than the inner diameter of the spinning needle 111a, a first driving unit 130 for reciprocating the piercing unit 120 up and down relative to the spinning nozzle unit 100, and a first cleaning unit 140 (see FIG. 5) for chemically cleaning the spinning needle 111a by spraying a cleaning solvent to the outside of the tip of the spinning needle 111a, a second cleaning unit 150 having at least one rotating brush 151, 152 disposed around a left and/or right side of the tip of the spinning needle 111a to physically clean the outside of the tip of the spinning needle 111a, and a second driving unit 155 for linearly reciprocating or rotating the second cleaning unit 150 and the rotating brush 151, 152 with respect to the spinning needle 111a.

The spinning nozzle unit 110 has an inner space formed by coupling an upper nozzle body 112 and a lower nozzle body 113 to form one body, and the spinning solution introduced from the solution reservoir is accommodated and retained in the inner space. At this time, a solution inlet 116 may be formed in the upper nozzle body 112 or the lower nozzle body 113. In addition, the upper nozzle body 112 and the lower nozzle body 113 may be configured as one integral body such as a cylindrical pipe. Inside the upper nozzle body 112 and the lower nozzle body 113, a metal electric conductive portion for applying a high voltage is provided.

The inner space is a space where the introduced spinning solution temporarily stays while being discharged through the plurality of spinning needles 111a or where the spinning solution is stored when the process is stopped. The height of the inner space is preferably designed to be 1 mm to 30 mm, more preferably 3 mm to 10 mm when used as a stay space, and is preferably designed to be 20 mm to 500 mm when used as a storage space.

In the upper nozzle body 112, at least one spinning cartridge 111 where a plurality of spinning needles 111a for discharging a spinning solution are arranged on a spinning needle support 111b is held by the upper nozzle body 112 in a state of being arranged side by side. In addition, in order to firmly fix the spinning cartridge 111 held by the upper nozzle body 112 to the upper nozzle body 112, a nozzle cover 114 is covered on the upper nozzle body 112.

The plurality of spinning needles 111a are preferably disposed on the spinning cartridge 111 at intervals of 2 mm to 50 mm. In order to mass-produce nanofibers, it is more preferable to integrate the spinning needles 111a at a high density with an interval of 3 mm to 10 mm.

The spinning needle 111a is configured using a hollow needle having an inner diameter of 0.1 mm to 2.5 mm and an outer diameter of 0.2 mm to 3 mm, or is configured by tubing. The spinning needle 111a may be made of stainless steel (SUS) or copper, or may be made of quartz tube, silica, or poly(etheretherketone) (PEEK). When the spinning needle 111a is made of SUS-based metal, an insulating material such as polyethylene or fluorine-based material may be coated or covered on the outside thereof. The spinning needle support 111b may be made of PEEK, fluorine-based polymer (Teflon), or electrically conductive stainless steel (SUS). Meanwhile, a sleeve may be formed at an end of the spinning needle 111a so that the spinning needle 111a may be easily coupled to the spinning needle support 111b or easily replaced. The sleeve may be a hollow tube or a hollow screw with a thread on the outside. The sleeve is preferably made of a polymer-based material having ductility and elasticity or a copper (Cu)-based material. For example, the sleeve is preferably made of a soft material with chemical resistance, such as fluorinated ethylene propylene (FEP), perfluoroalkoxyalkane (PFA), or polytetrafluoroethylene (PTFE). In addition, a hollow tube made of a conductive polymer material containing carbon and metallic components may be applied to impart conductivity to the sleeve. When the sleeve is a hollow tube, in order to increase adhesion with the spinning needle 111a, it is preferable that the sleeve uses a hollow tube having an inner diameter equal to or smaller than the outer diameter of the spinning needle 111a. For example, the sleeve preferably has an inner diameter of 0.05 mm to 4 mm and an outer diameter of 1 mm to 5 mm.

In the lower nozzle body 113, a plurality of guide needles 113a for guiding the piercing needle 121a to accurately enter the inside of the spinning needle 111a without being displaced are held in a state of being arranged on the guide needle support 113b in a one-to-one correspondence with the spinning needle 111a. The guide needle 113a preferably has an inner diameter and an outer diameter identical to those of the spinning needle 111a, but a larger hollow needle may also be applied. In addition, the guide needle 113a is disposed below the spinning needle 111a by a predetermined distance, and the separation distance (d₂) is preferably 1 mm to 10 mm.

In addition, a sealing cover 115 is coupled to the lower surface of the lower nozzle body 113 to prevent the spinning solution staying in the inner space from leaking out through a gap between the guide needle 113a and the piercing needle 121a. A sealing material such as a silicone O-ring suitable for the diameter of the piercing needle 121a is disposed on the sealing cover 115. By doing so, in a state where the piercing needle 121a penetrates the guide needle 113a and enters the spinning needle 111a, the gap between the guide needle 113a and the piercing needle 121a is sealed by the sealing material.

The piercing unit 120 includes a piercing holder 122 for holding at least one piercing cartridge 121 in which a plurality of piercing needles 121a are arranged on a piercing needle support 121b.

The piercing needle 121a is a rod, hollow needle, wire, or the like having a diameter smaller than the inner diameter of the spinning needle 111a and/or the guide needle 113a. The piercing needle 121a is coaxially disposed inside the guide needle 113a, and the front end of the piercing needle 121a is preferably located in the same level as the front end of the guide needle 113a or located therebelow with a separation distance (d₃) of less than 5 mm. The diameter of the piercing needle 121a is preferably smaller than the inner diameter of the spinning needle 111a by 0.005 mm to 1 mm.

The piercing cartridge 121 and the piercing needle 121a are made of electrically conductive SUS-based metal, and an external high voltage is applied to the piercing cartridge 121. Accordingly, the high voltage applied to the piercing cartridge 121 passes through the piercing needle 121a to the spinning solution inside the spinning needle 111a.

The gap between the piercing needles 121a arranged in the piercing cartridge 121 must be the same as the gap between the spinning needles 111a arranged in the spinning cartridge 111.

The first driving unit 130 is an up and down driving mechanism for reciprocating the piercing unit 120 up and down relative to the spinning nozzle unit 110, and is preferably a double-acting pneumatic cylinder or a single-acting pneumatic cylinder combined with a spring. Of course, the first driving unit 130 includes all kinds of up and down reciprocating driving means known in the art such as a motor or a manual steering wheel. However, in a high voltage environment such as the electrospinning device according to the present disclosure, a pneumatic driving mechanism such as a pneumatic cylinder 135 is more preferable.

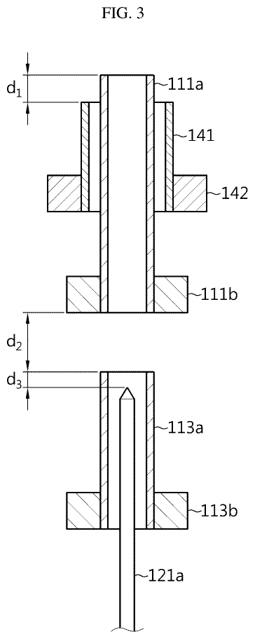

The first cleaning unit 140 is for chemically cleaning the spinning needle 111a by spraying a cleaning solvent to the outside of the tip of the spinning needle 111a. For example, referring to FIGS. 3 to 5, the first cleaning unit 140 is implemented by coaxially disposing a plurality of cleaning needles 141 having an inner diameter greater than the outer diameter of the spinning needle 111a by 0.1 mm to 5 mm on the cleaning support 142 having an inner space formed to accommodate the cleaning solvent injected from the outside in a one-to-one correspondence with the spinning needle 111a. As shown in FIGS. 3 to 5, the cleaning needle 141 is coaxially disposed at a low position to be spaced apart from the front end of the spinning needle 111a by a predetermined distance (d₁), and for example, d₁ is preferably 0.1 mm to 5 mm. The cleaning needle 141 is made of SUS-based metal, poly(etheretherketone) (PEEK), fluorine-based polymer, polyethylene-based polymer, or polypropylene-based polymer.

Accordingly, by discharging the cleaning solvent around the tip of the spinning needle 111a through the cleaning needle 141, aggregates or contaminants deposited on the tip of the spinning needle 111a may be dissolved and removed. The cleaning support 142 is preferably disposed close to the upper portion of the nozzle cover 114 or to be spaced apart therefrom by a predetermined distance.

The arrangement and interaction of the spinning needle 111a, the guide needle 113a, the piercing needle 121a, and the cleaning needle 141 will be described in detail with reference to FIGS. 3 to 5.

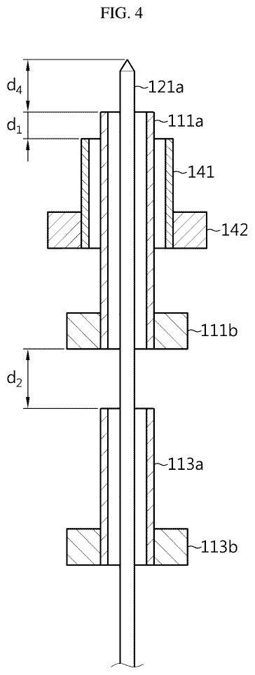

FIG. 3 is a needle arrangement diagram showing the mutual arrangement relationship between needles before piercing, FIG. 4 is a needle arrangement diagram showing the mutual arrangement relationship between needles after piercing, and FIG. 5 is a needle arrangement diagram showing the mutual arrangement relationship between needles during solvent cleaning. In particular, FIGS. 3 to 5 are diagrams conceptualizing the arrangement relationship of needles according to the progress of the electrospinning process.

First, referring to FIG. 3, in the double-tube needle structure in which the cleaning needle 141 coaxially surrounds the spinning needle 111a, the guide needle 113a for guiding the piercing needle 121a is disposed coaxially below the spinning needle 111a to be spaced apart therefrom by a predetermined distance (d₂). As the electrospinning process starts, the polymer solution (spinning solution) transferred from the outside is discharged to the outside through the tip of the spinning needle 111a.

In addition, when the electrospinning process is temporarily stopped, the spinning needle 111a may be clogged or aggregates may stick to the outside of the tip due to solidification of the solution on the tip of the spinning needle 111a or penetration of external contaminants. In this case, as shown in FIG. 4, the first driving unit 130 is operated to elevate the piercing needle 121a upward so that the piercing needle 121a is guided by the guide needle 113a and enter the spinning needle 111a to pass through the spinning needle 111a so as to protrude to the outside while piercing the clogged tip. In a state where the piercing needle 121a pierces the tip of the spinning needle 111a and protrudes to the outside as above, the first driving unit 130 is operated reversely to lower the piercing needle 121a, so that the piercing needle 121a moves down to its original position and is guided into the guide needle 113a as shown in FIG. 3. At this time, the protruding length (d₄) of the piercing needle 121a through the clogged tip of the spinning needle 111a is preferably 0.5 mm to 20 mm from the front end of the spinning needle 111a.

As the up and down reciprocation of the piercing needle 121a is repeated at least once through the first driving unit 130, the piercing needle 121a reciprocates up and down with respect to the tip of the spinning needle 111a to clearly pierce the tip that is clogged due to solidification of the solution at the tip of the spinning needle 111a. In particular, if the cleaning solvent is discharged through the cleaning needle 141 as shown in FIG. 5 during the relative up-and-down reciprocation of the piercing needle 121a and the spinning needle 111a, aggregates and the like adhered to the outside of the tip of the spinning needle 111a may be chemically cleaned clearly.

In the present disclosure, as shown in FIG. 5, the spinning needle 111a, the piercing needle 121a, and the cleaning needle 141 are coaxially arranged to form a three-tube needle structure so that piercing and cleaning can be performed simultaneously.

This three-tube needle structure preferably has dimensions as shown in Table 1 below, for example.

TABLE 1

| spinning needle 111a | | | | cleaning needle 141 | | |
|---|---|---|---|---|---|---|
| | inner | outer | piercing | | inner | outer |
| | diameter | diameter | needle 121a | | diameter | diameter |
| gauge | [mm] | [mm] | Diameter [mm] | gauge | [mm] | [mm] |
| 13G | 1.90 | 2.41 | 1.60~1.88 | 19G | 1.90 | 2.41 |
| 14G | 1.60 | 2.10 | 1.30~1.58 | 19G | 1.60 | 2.10 |
| 16G | 1.26 | 1.65 | 0.90~1.24 | 13G | 1.90 | 2.41 |
| 17G | 1.07 | 1.50 | 0.70~1.21 | 13G | 1.90 | 2.41 |
| 18G | 1.86 | 1.26 | 0.60~0.84 | 14G | 1.60 | 2.10 |
| 19G | 0.68 | 1.07 | 0.40~0.66 | 16G | 1.26 | 1.65 |
| 20G | 0.60 | 0.90 | 0.30~0.58 | 17G | 1.07 | 1.50 |
| 21G | 0.50 | 0.80 | 0.20~0.48 | 17G | 1.07 | 1.50 |
| 22G | 0.41 | 0.70 | 0.20~0.39 | 18G | 0.86 | 1.26 |
| 23G | 0.33 | 0.63 | 0.15~0.31 | 18G | 0.86 | 1.26 |
| 24G | 0.31 | 0.54 | 0.15~0.29 | 19G | 0.68 | 1.07 |
| 25G | 0.26 | 0.50 | 0.15~0.24 | 19G | 0.68 | 1.07 |

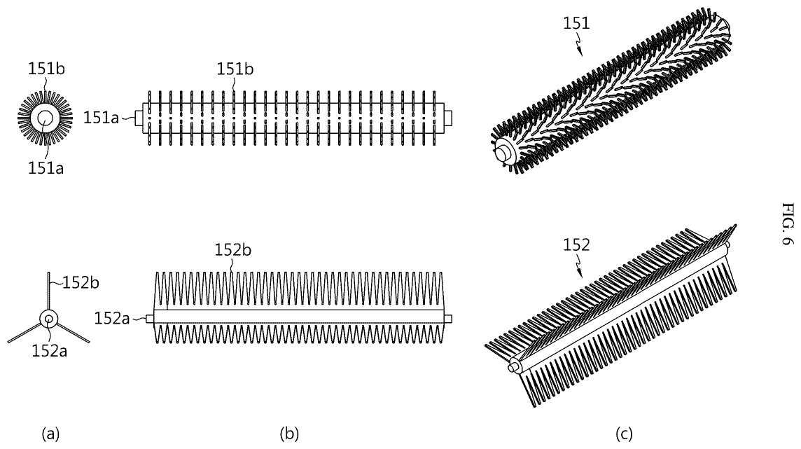

The second cleaning unit 150 according to this embodiment is a physical cleaning tool that physically cleans the outside of the tip of the spinning needle 111a by disposing at least one rotating brush 151, 152 on the left and/or right side of the tip of the spinning needle 111a. To this end, the present disclosure may further include a second driving unit 155 for linearly reciprocating the rotating brush 151, 152 with respect to the spinning needle 111a or rotating the rotating brush 151, 152 around the round bar 151a, 152a. FIGS. 6(a), 6(b) and 6(c) are a side view, a front view and a perspective view showing a rotating brush according to the present disclosure, respectively.

Referring to FIG. 6, the rotating brush 151, 152 may be configured by forming a roll comb 151b or a flat tail comb 152b on the round bar 151a, 152a. The roll comb 151b or the tail comb 152b formed on the round bar 151a, 152a may be configured to have the same tooth interval as the gap of the spinning needles 111a or to be more dense. The roll comb 151b or tail comb 152b is suitably made of flexible plastic having a thin diameter, and in particular, the roll comb 151b or tail comb 152b may be made of silicone or urethane with elasticity. The round bar 151a, 152a may be made of insulator plastic or metal. The at least one rotating brush 151, 152 according to the present disclosure may be disposed alone on the left side or on the right side of the tip of the spinning needle 111a, but it is most preferable that a pair of rotating brushes 151, 152 are respectively disposed on both sides of the tip of the spinning needle 111a. At this time, both of the pair of rotating brushes 151, 152 may be a roll comb rotating brush 151 or a tail comb rotating brush 152. Also, it is possible that one of them is a roll comb rotating brush 151 and the other is a tail comb rotating brush 152.

The pair of rotating brushes 151, 152 are disposed on the left and right sides of the spinning needle 111a to be spaced apart from each other by a predetermined distance. As the cleaning work starts, the pair of rotating brushes 151, 152 move close enough to come into close contact with the spinning needle 111a, and then wipes off aggregates adhering to the outside of the spinning needle 111a while rotating around the round bar 151a, 152a. At this time, if necessary, only one of the pair of rotating brushes 151, 152 may be moved toward the spinning needle 111a and perform cleaning. The rotating brush 151, 152 is preferably rotated at a rotational speed of 5 to 500 rpm. The cleaning work using the rotating brush 151, 152 is preferably performed in a state where the piercing needle 121a protrudes through the front end of the spinning needle 111a in order to safely maintain the spinning needle 111a.

Meanwhile, the second driving unit 155 is a driving mechanism for linearly reciprocating the rotating brush 151, 152 with respect to the spinning needle 111a or rotating the rotating brush 151, 152 around the round bar 151a, 152a, and may include a single-acting pneumatic cylinder including a motor and a spring, a double-acting pneumatic cylinder, a manual handle, and the like.

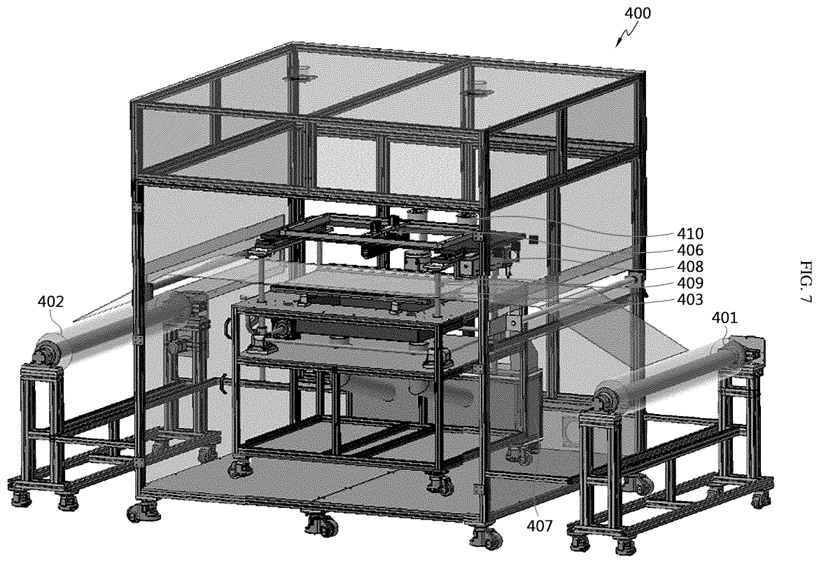

FIG. 7 is a diagram showing a top-down roll-to-roll electrospinning device according to a preferred embodiment of the present disclosure.

Referring to FIG. 7, the top-down roll-to-roll electrospinning device 400 according to the present disclosure includes an unwinder unit 401 serving as an unwinding unit that unwinds a roll on which a substrate for stacking nanofibers by spinning a spinning solution is wound, a winder unit 402 serving as a winding unit that winds the substrate on which the nanofibers are stacked, a nozzle block 406 having the above-described cleaning unit according to a preferred embodiment of the present disclosure, a collector 403 for stacking nanofibers emitted from the nozzle block 406 while transferring the substrate, and a solution reservoir for storing the spinning solution.

In addition, the top-down roll-to-roll electrospinning device 400 of the present disclosure further includes a solution transfer mechanism 410 having a plunger for pushing the solution in the solution reservoir and a solution transfer pump for operating the plunger to precisely transfer the spinning solution to the nozzle block 406, a high voltage power supply 407 for imparting (+) or (−) polarity to the spinning solution by applying a high voltage to the spinning solution in order to make the spinning solution discharged from the spinning needle of the nozzle block 406 into fine fibers having a diameter of nanometers (nm) or micrometers (um), a robot driving unit 408 for reciprocating the nozzle block 406 in the width direction of the substrate, a spinning distance adjusting unit 409 for adjusting the distance between the collector 403 and the tip of the spinning needle 111a, and a collection guide unit disposed on the left and right sides of the nozzle block 406 in the direction along which the substrate is transferred to stack the spun nanofibers in a limited area of the collector 403.

The collection guide unit controls the nanofibers emitted at both ends of the spinning nozzle so that the nanofibers are not pushed outward and spread out but are integrated into the limited inner area of the collector 403. To this end, a high voltage of the same polarity as the high voltage applied to the spinning solution may be applied to the collection guide unit, or a pneumatic airflow may be used.

The solution reservoir is made of insulating material such as polypropylene (PP), polyethylene (PE), polyetheretherketone (PEEK), MC nylon (Nylon), and acetal, which have excellent voltage resistance. In particular, it is preferable that the solution reservoir has a dual structure in which the inside is made of SUS metal and a cover made of MC nylon or polypropylene (PP) is provided on the outside of the SUS metal. The capacity of the solution reservoir is preferably 10 ml to 3,000 ml.

The solution transfer mechanism 410 may be transformed to include a motor, a screw connected to the shaft of the motor, a pusher fastened to the screw to push the plunger located inside the solution reservoir, a guide rod for connecting the plunger and the pusher, and a linear motion guide unit for smoothly converting the pusher into linear motion. At this time, the lead of the screw is 0.5 mm to 2 mm, preferably 1 mm. In addition, the moving speed of the pusher according to the rotation of the screw preferably has a minimum speed of 1 um/hour to 100 um/hour and a maximum speed of 1 cm/minute to 20 cm/minute. The plunger extrudes the spinning solution as moving forward inside the solution reservoir by operating an external motor. The plunger may also be driven using a pneumatic machine instead of a motor.

In addition, when the capacity of the solution reservoir is insufficient, the solution transfer pumps of the solution transfer mechanism 410 may be provided in two sets (first solution transfer pumps and second solution transfer pumps) in parallel, and a three-way valve may also be configured to transfer the spinning solution.

In addition, the top-down roll-to-roll electrospinning device 400 of the present disclosure may further include a hot air generator for producing fine nanofibers by volatilizing a solvent from a large amount of spinning filaments emitted from spinning needles of the nozzle block 406, and a humidity controller for controlling the solvent volatilization rate by adjusting the internal humidity of the electrospinning device 400, and a laminator for adjusting the coupling state of the nanofibers formed on the substrate.

In addition, the top-down roll-to-roll electrospinning device 400 of the present disclosure may further include a video camera that monitors the solidified state or clogged state of the spinning solution formed at the front end of the spinning needle or the droplet state of the Taylor cone formed at the tip of the spinning needle in real time, and store the monitored result as a video or image. The video camera is provided at the bottom of the side surface of the nozzle block 406 and moves back and forth to check the state of the front end of the spinning needle in real time or to take images.

Hereinafter, the operation of the top-down roll-to-roll electrospinning device 400 of the present disclosure will be described.

The spinning solution transferred from the solution reservoir by the solution transfer mechanism 410 is discharged from the spinning needle 111a of the nozzle block 100, 406 toward the collector 403. However, if the spinning needle 111a is clogged during the electrospinning process, the first driving unit 130 is operated to reciprocate the piercing needle 121a guided inside the guide needle 113a up and down with respect to the spinning needle 111a so that the clogging of the spinning needle 111a is removed by repeating the reciprocating piercing work in which the piercing needle 121a protrudes through the tip of the spinning needle 111a and then returns to the original position at least once.

In addition, at least one rotating brush 151, 152 (or, more preferably, a pair of rotating brushes) disposed on the left and/or right side of the spinning needle 111a to be spaced apart therefrom is moved toward the spinning needle 111a to be brought into close contact with the spinning needle 111a by operating the second driving unit 155 in order to clean contaminants or solidified materials accumulated around the tip of the spinning needle 111a, and the at least one rotating brush 151, 152 is rotated around the round bar 151a, 152a, thereby performing a physical cleaning work for cleaning the tip of the spinning needle 111a using the friction of the roll comb 151b and/or the tail comb 152b. After the physical cleaning work is completed, if necessary, the cleaning solvent is discharged through the cleaning needle 141 as shown in FIG. 5 to perform a chemical cleaning work for washing and cleaning the tip of the spinning needle 111a, for which the reciprocating piercing work and the physical cleaning work described above are completed, with a cleaning solvent.

In the electrospinning process of the present disclosure, it is desirable that the discharge amount of the spinning solution per spinning needle is 0.5 μl/min to 500 μl/min, preferably 1 μl/min to 100 μl/min, in manufacturing nanofibers. A high voltage is applied to the spinning needle 111a through the piercing support 121b and the piercing needle 121a by the high voltage power supply 407, and the intensity of the voltage is suitably 0.01 kV/cm to 10 kV/cm, preferably 0.5 kV/cm to 6 kV/cm.

The collector 403 is configured using a conveyor, multiple rollers, or multiple wires that can rotate together with the substrate, so that the collector 403 rotates idle while reducing friction while the substrate is moving. The collector 403 is made of a conductive material such as a metallic material, and may be grounded or applied with a DC power (1 kV to 20 kV) having a polarity opposite to that of the charging solution. The transfer speed of the substrate is preferably 10 cm per minute to 50 cm per minute. In addition, the hot air injected to volatilize the solvent included in the charging solution discharged through the spinning needle 111a into the air is set within the wind speed of 0.1 msec to 10 msec and the temperature range of 20° C. to 150° C. The temperature of the hot air is more preferably 30° C. to 80° C.

If the electrospinning device of the present disclosure is used, the clogging phenomenon due to solidification of the solution at the tip of the spinning needle caused by volatilization of the solvent can be prevented, and the tip of the spinning needle can be cleaned clearly. Thus, there is no need to replace the nozzle for the progress of subsequent processes, so the continuity of the spinning process can be secured. In particular, the nozzle block of the present disclosure can also be applied to a bottom-up roll-to-roll electrospinning device.

As described so far, the electrospinning device according to the present disclosure and the nozzle block applied thereto have been expressed in the description and drawings, but this is only an example, so the idea of the present disclosure is not limited to the description and drawings, and various changes and modifications will be possible within the scope that does not deviate from the technical idea of the present disclosure.

In addition, since various substitutions, modifications, and changes are possible to those skilled in the art within the scope of the technical idea of the present disclosure, the present disclosure is not limited by the above embodiment and the accompanying drawings.

1. A nozzle block having a cleaning unit, which is applied to electro spinning, the nozzle block comprising:
a spinning nozzle having a plurality of hollow spinning needles for discharging a spinning solution to the outside;
a piercing unit having a smaller diameter than the spinning needle and disposed coaxially with the spinning needle;
at least one rotating brush disposed on the left and/or right side of each spinning needle to clean the outside of the spinning needle by rotation; and
a reciprocating unit configured to reciprocate the piercing unit and the spinning needle relative to each other,
wherein clogging of a tip of the spinning needle is pierced by reciprocating the piercing unit and the spinning needle relative to each other, and aggregates deposited on the outside of the tip of the spinning needle are cleaned by using the at least one rotating brush.

2. The nozzle block having a cleaning unit according to claim 1, further comprising:
a hollow guide needle disposed below the spinning needle to be spaced apart by a predetermined distance in a coaxial direction and having an inner diameter and outer diameter equal to or greater than that of the spinning needle to guide the piercing unit to accurately enter the inside of the spinning needle without error.

3. The nozzle block having a cleaning unit according to claim 2,
wherein a separation distance between the spinning needle and the guide needle is 1 mm to 10 mm.

4. The nozzle block having a cleaning unit according to claim 2, further comprising:
a cleaning needle having an inner diameter greater than the outer diameter of the spinning needle and disposed to coaxially surround the spinning needle to clean the tip of the spinning needle by discharging a cleaning solvent.

5. The nozzle block having a cleaning unit according to claim 2, further comprising:
a rotating unit configured to linearly reciprocate the rotating brush with respect to the spinning needle and rotate the rotating brush around a central axis.

6. The nozzle block having a cleaning unit according to claim 5,
wherein the rotating brush is a brush having a roll comb disposed on a round bar or a brush having a tail comb disposed on a round bar.

7. The nozzle block having a cleaning unit according to claim 1,
wherein the piercing unit is coaxially disposed inside the guide needle, and a front end of the piercing unit is located at the same level as a front end of the guide needle or located therebelow within 5 mm.

8. The nozzle block having a cleaning unit according to claim 7,
wherein the diameter of the piercing unit is smaller than the inner diameter of the spinning needle by 0.005 mm to 1 mm.

9. The nozzle block having a cleaning unit according to claim 8,
wherein the piercing unit is a wire having a diameter smaller than the inner diameter of the spinning needle.

10. The nozzle block according to claim 8,
wherein the piercing unit is a hollow piercing needle having an outer diameter smaller than the inner diameter of the spinning needle.

11. The nozzle block having a cleaning unit according to claim 1,
wherein the reciprocating unit is a pneumatic driving mechanism for reciprocating the piercing needle up and down relative to the spinning needle.

12. The nozzle block having a cleaning unit according to claim 4,
wherein the cleaning needle has an inner diameter greater than the outer diameter of the spinning needle by 0.1 mm to 5 mm.

13. The nozzle block having a cleaning unit according to claim 4,
wherein the cleaning needle is disposed coaxially below a front end of the spinning needle by 0.1 mm to 5 mm.

14. The nozzle block having a cleaning unit according to claim 1,
wherein the at least one rotating brush is a pair of rotating brushes disposed on left and right sides of a front end of the spinning needle to be spaced apart from each other by a predetermined distance.

15. The nozzle block having a cleaning unit according to claim 1,
wherein the piercing needle is protruded so that the piercing needle has a protrusion length of 0.5 mm to 20 mm.

16. The nozzle block having a cleaning unit according to claim 1, further comprising:
a first nozzle support configured to support and fix at least two spinning needles arranged in a row;
a second nozzle support configured to support and fix at least two guide needles arranged in a row so as to correspond to the spinning needles fixed to the first nozzle support; and
a third nozzle support configured to support and fix at least two piercing needles arranged in a row so as to be guided into the guide needles fixed to the second nozzle support.

17. The nozzle block having a cleaning unit according to claim 16, further comprising:
a fourth nozzle support configured to support and fix at least two cleaning needles arranged in a row so as to coaxially surround at least a part of a front end of the spinning needle.

18. An electrospinning device, comprising:
an unwinding unit configured to unwind a substrate to be stacked with nanofibers by spinning a spinning solution;
a winding unit configured to wind the substrate on which the nanofibers are stacked;
a nozzle block according to claim 1;
a collector configured to transfer the substrate to stack the nanofibers emitted from the nozzle block;
a solution reservoir configured to store the spinning solution;
a solution transfer mechanism configured to transfer the solution of the solution reservoir to the nozzle block; and
a high voltage power supply configured to apply a high voltage to the spinning solution discharged from the spinning needle of the nozzle block.

19. The electrospinning device according to claim 18, further comprising:
a robot driving unit configured to reciprocate the nozzle block in a width direction of the substrate; and
a spinning distance adjusting unit configured to adjust a distance between the collector and the tip of the spinning needle.

20. The electrospinning device according to claim 18, further comprising:
a hot air generator configured to produce fine nanofibers by volatilizing a solvent from a large amount of spinning filaments discharged from the spinning needles of the nozzle block;
a humidity controller configured to control a solvent volatilization rate by adjusting internal humidity; and
a laminator configured to adjust a coupling state of the nanofibers formed on the substrate.

21. The electrospinning device according to claim 18, further comprising:
a video camera configured to monitor a solidified state or clogged state of the spinning solution formed at a front end of the spinning needle or a droplet state of Taylor cone formed at the tip of the spinning needle in real time.

22. The electrospinning device according to claim 18, further comprising:
a collection guide unit disposed on left and right sides of the nozzle block to stack the spun nanofibers in a limited area of the collector.
